(19) United States
(12) Patent Application Publication
(10) Pub. No.: US 2022/0203818 A1
(43) Pub. Date: Jun. 30, 2022

(54) Transmission Assembly for a Motor Vehicle and Method for Installing a Transmission Assembly

(71) Applicant: ZF Friedrichshafen AG, Friedrichshafen (DE)

(72) Inventors: Fabian Kutter, Kressbronn (DE); Johannes Kaltenbach, Friedrichshafen (DE); Matthias Horn, Tettnang (DE); Uwe Griesmeier, Markdorf (DE); Stefan Beck, Eriskirch (DE)

(21) Appl. No.: 17/605,660

(22) PCT Filed: Mar. 4, 2020
(86) PCT No.: PCT/EP2020/055602

§ 371 Date: Oct. 22, 2021

(30) Foreign Application Priority Data
Apr. 23, 2019 (DE) 10 2019 205 757.8

(51) Int. Cl. B60K 6/365; B60K 6/405; B60K 6/48; F16H 57/02

(52) U.S. Cl. CPC B60K 6/365; B60K 6/405; B60K 6/547; F16H 57/02; F16H 2057/02034; B60K 6/48

(57) ABSTRACT

A transmission arrangement for a motor vehicle includes a first housing part, a second housing part, an electric machine at least partially within the first housing part, an internal combustion engine having a component at least partially within the second housing part, and a transmission. The electric machine and the component of the internal combustion engine being connectable to an output shaft of the transmission to transmit torque to the output shaft. The transmission arrangement further includes an intermediate shaft connected to the output shaft to transmit the torque to a drive axle of the motor vehicle, and an intermediate wall. The first and second housing parts are connectable to each other to together define a common interior space, the transmission and at least part of the intermediate shaft being within the common interior space. The intermediate wall delimits a subspace of the common interior space from remaining space of the common interior space, with the electric machine being within the subspace. The intermediate shaft is supported on the intermediate wall at a side of the electric machine.

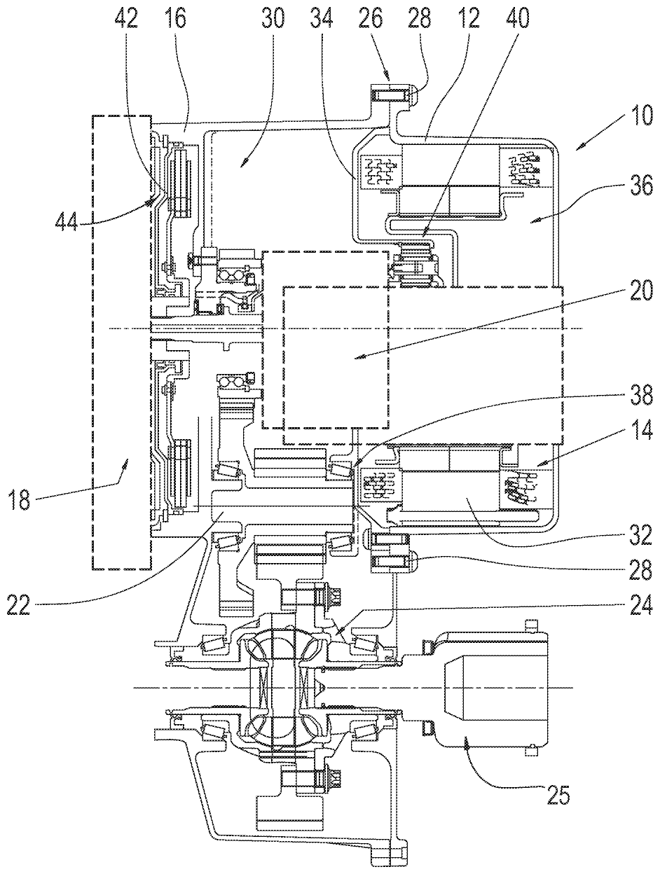

### CROSS-REFERENCE TO RELATED APPLICATION

The present application is related and has right of priority to German Patent Application No. 10 2019 205 757.8 filed on Apr. 23, 2019 and is a nationalization of PCT/EP2020/055602 filed in the European Patent Office on Mar. 4, 2020, both of which are incorporated by reference in their entirety for all purposes.

### FIELD OF THE INVENTION

The present application relates generally to a transmission arrangement for a motor vehicle and to a method for assembling the transmission arrangement.

### BACKGROUND

Motor vehicles optionally have more than one drive device. In particular, the combination of at least one electric motor and one internal combustion engine is advantageous with regard to consumption, environmental protection, and power. For this purpose, however, both the electric motor and the internal combustion engine must be integrated into the drive train of the motor vehicle in order to transmit the particular input power onto the vehicle wheels. For good efficiency, it is advantageous when this integration also provides various gear stages. For this purpose, a transmission arrangement of a motor vehicle includes at least one transmission, by which the electric motor and the internal combustion engine are connected or are connectable to a drive axle in order to transmit torque.

U.S. Pat. No. 4,507,978 describes, for example, an electric starter, which is connected to a planetary transmission.

### SUMMARY OF THE INVENTION

Aspects of the present invention provide an improved transmission arrangement for a motor vehicle and an improved method for assembling a transmission arrangement.

A first example aspect relates to a transmission arrangement for a motor vehicle. The transmission arrangement includes an electric machine arranged in a first housing part, and an internal combustion engine having a component accommodated in a second housing part. The electric machine forms a starter and/or a generator of the motor vehicle, wherein a combination of starter and generator is also referred to as a “starter generator.” The electric machine also forms a hybrid drive of the motor vehicle together with the internal combustion engine. Alternatively, or additionally, the electric machine drives the motor vehicle. The internal combustion engine is, for example, a gas engine or a diesel engine and is utilized for driving the motor vehicle and/or for power generation, in particular by the electric machine.

In addition, the transmission arrangement includes a transmission, by which both the electric machine and the internal combustion engine, in particular the component of the internal combustion engine that is arrangeable or arranged in the second housing part, are connectable to an output shaft of the transmission in order to transmit torque. The transmission provides particular ratios and/or coupling conditions for an output shaft of the electric machine and an output shaft of the internal combustion engine. For example, a torque is transmitted from the electric machine to the output shaft at a different ratio than a torque from the internal combustion engine to the output shaft. Similarly, particular coupling conditions and/or ratios are provided by the transmission for starting the internal combustion engine by the electric machine or for generating power by the internal combustion engine by the electric machine. An optional coupling and decoupling of the electric machine and/or the internal combustion engine are also provided by the transmission, in order, for example, to be able to drive purely electrically, purely with combustion force, or in a hybrid mode. The transmission preferably includes one or multiple planetary gear set(s), in particular planetary gear sets coupled and/or nested with one another. A planetary gear set includes, for example, a ring gear, a sun gear, and a planet carrier having one or multiple planet gear(s) retained thereon.

In addition, the transmission arrangement includes an intermediate shaft, which is connected to the output shaft in order to transmit torque and transmits a torque to a differential of the motor vehicle and/or a drive axle of the motor vehicle. The intermediate shaft bridges an axial offset between a main axis of the transmission and of the differential or the axle of the motor vehicle. The differential is also referred to as a differential gear. The intermediate shaft is therefore connected to the output shaft of the transmission. In this way, a drive power is made available at the wheels and/or the drive axle by the internal combustion engine and/or the electric machine. The intermediate shaft, for example, enables an axial offset of the drive axle and/or the differential with respect to the output shaft of the transmission. As a result, the internal combustion engine, the electric machine, and/or the transmission itself are arranged essentially on a straight line, for example, with their particular centroids and/or main axes, as the result of which the transmission arrangement is particularly suitable for a transverse arrangement in the motor vehicle. In a transverse arrangement, a main extension is essentially parallel to a transverse direction of the motor vehicle.

The two housing parts are connected to each other, in particular in the installed condition in a motor vehicle. In the connected or installed condition, the two housing parts form a common interior space, in which the transmission is arranged. The intermediate shaft is partially arranged in the interior space. For this purpose, the interior space formed by the two housing parts has an opening, a recess, and/or a passage, in which the intermediate shaft is partially or completely arranged. In this way, the intermediate shaft enables a transmission of power and/or torque from the transmission onto the drive shaft and/or the differential of the motor vehicle.

The transmission arrangement also includes an intermediate wall delimiting a first subspace in which the electric machine in the interior space is arranged from the remaining interior space. Therefore, at least two subspaces are defined by the intermediate wall in the interior space: a first subspace, in which the electric machine is arranged, and a second subspace. The two subspaces make it possible to set different lube oil conditions, despite a common lube oil supply. For example, an amount of oil for cooling the electric machine is adapted in a targeted manner for the electric machine, regardless of the amount of oil for cooling and/or lubricating the transmission and/or the component of the internal combustion engine. Completely separate housings, which possibly need more space and/or more installation effort, are thus, dispensed with. A number of sealing points are also reduced in this way, in particular since the housing has only one separation point. Preferably, the component of the internal combustion engine is arranged completely in the second subspace. The transmission is arranged completely in the second subspace or partially in the first subspace and partially in the second subspace.

Preferably, in addition, the intermediate shaft is supported at the intermediate wall on the side of the electric machine defined as the side facing the electric machine and/or also designated as the electric machine-side. Within the scope of this description, a support of a component on the side of the electric machine or of the internal combustion engine means that this component is supported with its side that is facing the electric machine or the internal combustion engine, respectively, in particular at a component to be further specified. This support is axial and/or radial. An end of the intermediate shaft on the side of the electric machine corresponds to an axial end of the intermediate shaft that corresponds to the electric machine. An end on the side of the internal combustion engine is therefore an opposite end facing the component of the internal combustion engine defined as the side facing the internal combustion engine and/or designated as the internal combustion engine-side. The intermediate shaft extends preferably axially between the component of the internal combustion engine and the electric machine. The intermediate wall has a supporting point for this purpose, for example, in the form of a shoulder or a recess. Preferably, the supporting point helps locate a bearing and accommodate forces of the bearing. For example, the intermediate shaft is supported by a roller bearing or an antifriction bearing, in particular an angular roller bearing. An angular tapered roller bearing is alternatively utilized, for example.

Due to the support of the intermediate shaft at the intermediate wall on the side of the electric machine, additional elements and/or housing parts for providing the supporting point are dispensed with. In this way, the transmission arrangement is particularly axially compact. Preferably, an output gear or an output shaft of the transmission is arranged as close as possible in the direction of the internal combustion engine or its component, in order to avoid a long intermediate shaft. Only the installation space necessary for the component of the internal combustion engine must be taken into account. Due to the intermediate wall, the intermediate shaft is easily arranged radially outside the transmission, which is arranged between the electric machine and the component of the internal combustion engine. In this way, an axial overlap of the transmission and the intermediate shaft is achieved, with a axial and, if necessary, also radially compact manner. Simultaneously, an additional housing part for the intermediate shaft is dispensed with. In this way, the assembly is also simple. The intermediate shaft is arranged radially within the outer diameter of the electric machine, without the need to install the electric machine from a wheel side or a side facing away from the internal combustion engine. A cover on the side of a wheel for the housing area of the electric machine and its installation is dispensed with. The side of the wheel is defined as the side situated closest to the wheel or tire and/or also designated as wheel-side. The intermediate wall is positioned after the electric machine has been installed, i.e., at least after its stator has been installed, usually, however, also after the rotor, including any transmission parts, has been installed. With respect to the interior space, for example, only essentially one single housing connecting point, apart from, for example, typical access openings for sensors, supply lines, and the like, namely between the first housing part and the second housing part, must then also be sealed off toward the outside. The axial installation space is optimally utilized, wherein the critical length path is now the electric machine, the intermediate shaft, and the component of the internal combustion engine. The intermediate wall simultaneously forms the supporting point for the intermediate shaft and the interior space cover for the electric machine. Thus, the transmission arrangement include particularly few parts.

In one further embodiment of the transmission arrangement, it is provided that the intermediate shaft is supported at a wall of the second housing part on the side of the internal combustion engine. As a result, an additional component for supporting the intermediate shaft does not need to be provided here, either, as the result of which the transmission arrangement is also particularly simple to assemble. In this case as well, the supporting point includes, for example, a shoulder, an indentation, a projection, and/or a passage opening, at which a bearing, such as a tapered roller bearing, is arranged.

In one further embodiment of the transmission arrangement, it is provided that the wall of the second housing part, at which the intermediate shaft is supported on the side of the internal combustion engine, delimits a further subspace of the interior space for accommodating the component of the internal combustion engine with respect to the interior space. Therefore, a delineation from the rest of the interior space, in which the transmission and the electric machine are accommodated, takes place at the wall, in order to also be able to subject the component to another oil environment in a targeted manner. The wall has a passage opening, through which a shaft of the internal combustion engine or its component is connected or connectable to the transmission. The interior space therefore also has three subspaces.

Alternatively, the wall, at which the intermediate shaft is supported on the side of the internal combustion engine, delimits the interior space having the electric machine and the transmission and a second interior space at least partially formed by the second housing part for accommodating the component of the internal combustion engine. The component of the internal combustion engine and also the internal combustion engine itself is then accommodated, for example, in an interior space of another housing part, which is closed by the wall, at which the intermediate shaft is supported on the side of the internal combustion engine.

In one further embodiment of the transmission arrangement, the transmission arrangement is arranged in the motor vehicle in the transverse direction with the electric machine on the side of the wheel. As a result, the relatively heavy internal combustion engine is arranged relatively centrally in the motor vehicle. An arrangement of this type is made possible by the axially short extension due to the intermediate wall having supporting points. The alignment of the transmission arrangement is defined by particular axes of rotation, in particular the axial direction of the intermediate shaft. For example, the internal combustion engine is arranged in the center of the machine space, having an electric machine to the left and right thereof with respect to the vehicle, adjacent to the wheel in each case, with a transmission between each electric machine and wheel. In one example embodiment, only one electric machine is instead provided. Situated on the side of the wheel, for example, is the end of the transmission arrangement that is closest to a tire or a wheel of the motor vehicle, in particular in the transverse direction. Correspondingly, the intermediate wall is arranged with respect to the intermediate shaft on the side of the wheel or the intermediate shaft is supported at the intermediate wall on the side of the wheel.

In one further embodiment of the transmission arrangement, it is provided that the intermediate shaft is supported radially at least partially within a stator outer diameter of the electric machine. As a result, a great extent of axial nesting of the transmission arrangement and/or a small amount of necessary axial installation space for the transmission arrangement is achieved. In addition, the essential radial extension is limited to the diameter of the electric machine in this way. Preferably, at least the axis of rotation of the intermediate shaft or its central axis is arranged within the diameter of the stator of the electric machine. Therefore, the axis of rotation is also arranged radially within an outer circumference of the first housing part and, thereby, also the supporting point of the intermediate shaft on the side of the electric machine, which is advantageous with respect to an oil seal.

In one further embodiment of the transmission arrangement, it is provided that the first housing part has an assembly opening, through which the electric machine is insertable into and/or removable from the first housing part and this opening is essentially closed by the intermediate wall. This assembly opening corresponds to the opening in which the intermediate wall is inserted. In particular, the first housing part has a cup-like shape, which is closed by the intermediate wall. The assembly opening is therefore made accessible by removing the intermediate wall and is closed by installing the intermediate wall, similarly to a cover. As a result, a second opening to the first subspace of the interior space defined by the first housing part is not necessary in order to be able to establish a connection to the transmission or to install the electric machine. The electric machine is therefore installed on or from the side of the internal combustion engine and its interior housing region is closed by the intermediate wall. Preferably, only this one assembly opening is provided. The intermediate wall, together with the first housing part, therefore delimits an essentially oil-tight accommodating chamber for the electric machine.

In one further embodiment of the transmission arrangement, the intermediate wall seals with the first housing part and/or the second housing part. For example, the intermediate wall is sealed off with respect to adjacent areas of a housing part by a seal, such as a sealing ring or a labyrinth sealing, in order to form the different oil chambers. In this way, the transmission is supplied with a different amount of oil than the electric machine, wherein a common supply, such as a pump and a reservoir, is utilized.

In one further embodiment of the transmission arrangement, it is provided that the intermediate wall is attached at the first housing part and/or the second housing part. Preferably, the intermediate wall is detachably attached at the first housing part and/or the second housing part, as the result of which a simplified assembly of the transmission arrangement is made possible. For example, the intermediate wall is, in one example aspect, bolted to one of the two housing parts. In addition, a recess and/or a shoulder is provided in the first housing part and/or the second housing part, in or at which the intermediate wall is placed, which predefines the installation and/or attachment position. The assembly is simplified as a result thereof as well. The first housing part and the second housing part are fastened directly to one another or only indirectly via the intermediate wall. The intermediate wall, in one example aspect, is merely clamped between the two housing parts, as the result of which particularly few mounting parts are necessary.

In one further embodiment of the transmission arrangement, it is provided that the intermediate wall is essentially arranged in a parting plane between the first housing part and the second housing part. Preferably, the overall housing is separated in a direction transverse to the longitudinal extension, which, in particular, is parallel to the particular axes of rotation, such as the axis of rotation of the intermediate shaft. In other words: the housing is divided into two sections along its axial extension. Due to the arrangement of the intermediate wall essentially in this parting plane, the housing has only one separation point despite the intermediate wall and, therefore, is quickly and easily installed. In addition, therefore, only this one separation point is to be sealed. Additional access openings, for example, for sensors, are sealed separately therefrom, if necessary, or are also arranged at the separation point.

In one further embodiment of the transmission arrangement, the interior space of the transmission arrangement is essentially delimited only by the first housing part and the second housing part. As a result, the transmission arrangement has particularly few parts and sealing points. In this way, an essentially closed interior space is easily made available. The transmission arrangement or its housing is therefore has two shells, which is advantageous with regard to the number of parts and the installation effort. In addition to the two housing parts, the interior space is also delimited by seals, bolts, and further accessories, wherein, however, a basic shape and structural integrity is predefined by the two housing parts.

Preferably, it is provided with respect to the transmission arrangement that the transmission includes at least one planetary gear set, wherein at least one element of the planetary gear set is supported at the intermediate wall. In particular, the element of the planetary gear set is supported at the intermediate wall on the side of the electric machine. The element is, for example, a planet carrier, a ring gear, and/or a sun gear of the planetary gear set. Instead or additionally, the element of the planetary gear set of the transmission is supported at the intermediate wall. The above-described configuration of the intermediate wall and other housing parts is nevertheless identical or similar to that described above in connection with the support of the intermediate shaft at the intermediate wall, as a result of which similar advantages result. If the intermediate shaft as well as the element of the planetary gear set of the transmission are supported at the intermediate wall, a synergy results with respect to the compactness of the transmission arrangement and a necessary small number of parts. Multiple elements of the planetary gear set are also supported at the intermediate wall on the side of the electric machine, in order to enable a great stability of the transmission.

Due to the support of the element of the planetary gear set at the intermediate wall, the transmission arrangement is particularly compact, in particular in the axial direction. Additional parts for providing the support for the planetary gear set are dispensed with. The cover for the interior space region of the electric machine therefore closes off the interior space region as well as provides the supporting point for the transmission. The supporting point is, for example, a shoulder, a projection, or a passage opening. The passage opening is closed by the planetary gear set.

The element of the planetary gear set is preferably rotationally fixed to the intermediate wall, for example, by a bolted connection. Usually, at least one element of a planetary gear set is supported in a rotationally fixed manner, which is particularly easily implemented at the intermediate wall. The element is alternatively rotatably supported, however, when a bearing, such as an antifriction bearing, is provided at the supporting point.

Preferably, the element of the planetary gear set is at least radially supported at the intermediate wall. Additionally, the element of the planetary gear set is also axially supported at the intermediate wall. As a result, axial loads are also supported by the bearing, as the result of which the planetary gear set has a particularly simple design. Alternatively, particular axial loads are also supported in the planetary gear set itself, as the result of which the planetary gear set is supported in a manner free from axial loads. For this purpose, for example, particular tooth systems are appropriately aligned, in particular together with a second planetary gear set of the transmission.

Preferably, the transmission has two planetary gear sets, which are preferably connected to each other in order to transmit torque. As a result, a selective coupling and decoupling of the electric machine and the internal combustion engine independently of one another takes place and several different gear stages are selected for both drives, in order to connect these to the drive train. The two planetary gear sets make this possible in a particularly compact manner, particularly in an axially compact manner when the particular elements are nested. Preferably, an element of that planetary gear set of the two planetary gear sets on the side of the electric machine is then the element that is supported at the intermediate wall. The one planetary gear set that is situated closest to the electric machine is defined as the planetary gear set on the side of the electric machine. In particular, the two planetary gear sets are arranged axially next to one another with their particular main axes coaxial, wherein an at least partial axial nesting and/or overlap of the particular extension is also possible for a particularly compact design.

Preferably, the transmission is supported at a wall of the second housing part on the side of the internal combustion engine, particularly at the wall at which the intermediate shaft is also supported on the side of the internal combustion engine. As a result thereof, additional parts are dispensed with. In principle, the wall of the second housing part is described as in the case of the intermediate shaft, even though the intermediate shaft is not supported at this wall on the side of the internal combustion engine. The supporting point for the transmission is a recess, a shoulder, a projection, and/or a passage opening. The mounting takes place by a bearing or by a rotationally fixed connection, in particular of an element of the second planetary gear set.

In one further embodiment of the transmission arrangement, the component of the internal combustion engine is a clutch, an oil supply device, a system for ensuring uniformity of rotation, such as dual-mass flywheels, a torsional vibration mass damper, a torsional vibration damper, and an all-wheel drive divider, and/or a converter transmission. As a result, for example, forces are introduced particularly uniformly into the transmission, and as such, the intermediate wall must support particularly low loads from the intermediate shaft and/or the planetary gear set.

Particular shift elements of the transmission are preferably also coupled onto the housing and/or onto the intermediate wall.

A second aspect relates to a method for assembling a transmission arrangement, in particular a transmission arrangement according to the first aspect. The features and advantages resulting from the transmission arrangement according to the first aspect are derived from the descriptions of the first aspect, wherein embodiments of the first aspect are considered to be embodiments of the second aspect, and vice versa.

The method includes at least the step of providing a first housing part. The first housing part preferably has only one assembly opening, which is preferably arranged on the side of the internal combustion engine in the assembled transmission arrangement. In addition, the method includes inserting an electric machine into the first housing part. The electric machine is preferably installed through the assembly opening, i.e., on the side of the internal combustion engine. Access openings on another side, for example, the wheel side when the transmission arrangement is installed in the motor vehicle, are therefore dispensed with. In addition, the method includes the step of arranging an intermediate wall at the first housing part after inserting the electric machine. The arrangement also includes attaching the intermediate wall, in particular at the first housing part. In particular, initially, at least the stator of the electric machine is inserted before the intermediate wall is arranged and, if necessary, attached, preferably, however, the entire electric machine. The attachment is preceded by an insertion of the intermediate wall into the first housing part. The attachment takes place, for example, by bolting. Preferably, the intermediate wall closes the assembly opening of the first housing part. The intermediate wall therefore is also considered to be a cover for the interior space region having the electric machine.

In addition, the method includes supporting an intermediate shaft at the intermediate wall on the side of the electric machine after it has been attached at the first housing part. Alternatively, or additionally, the method also includes supporting an element of a planetary gear set at the intermediate wall on the side of the electric machine after it has been attached at the first housing part. An additional housing and/or connecting elements for supporting the planetary gear set and/or the intermediate shaft are therefore dispensed with.

In addition, the method includes attaching a second housing part, which is accommodates a component of an internal combustion engine, at the first housing part and/or the intermediate wall while forming an interior space. Preferably, the intermediate shaft and/or an element of the planetary gear set of the transmission are/is supported at a wall of the second housing part on the side of the internal combustion engine. Preferably, the second housing part is attached only after the intermediate shaft and/or the transmission have/has been arranged at the intermediate wall and/or supported thereon.

In addition, the method includes arranging a transmission in the interior space. This transmission, in one example aspect, is the above-described transmission including the planetary gear set. Preferably, the transmission is arranged at the intermediate wall before the second housing part is installed. In this way, a complete machine-side assembly of the transmission arrangement is possible.

The assembly therefore takes place consecutively from a starting point aligned, in the installation position, on the side of the wheel, in particular of the closest wheel, exclusively in the direction of the internal combustion engine, wherein only two housing parts are needed for closing a transmission interior, which are to be sealed from the outside.

In addition, the method includes, a step of arranging a component of the internal combustion engine at or in the second housing part, wherein this is also preferably installed from the internal combustion engine side.

The method is particularly simple, since installation takes place only from one direction. In addition, fewer parts, connections, and seals are needed, which also simplifies the assembly.

A further aspect relates to a motor vehicle including the transmission arrangement according to the first aspect. The transmission arrangement is preferably a front-mounted transverse transmission arrangement. Therefore, the transmission arrangement is arranged at the front of the motor vehicle in the transverse direction. The features and advantages resulting from the transmission arrangement according to the first aspect are to be derived from the descriptions of the first aspect, wherein embodiments of the first aspect are considered to be embodiments of the further aspect, and vice versa.

Further features result from the claims, the exemplary embodiment, and on the basis of the drawings. The features and combinations of features mentioned above in the description as well as the features and combinations of features mentioned in the following in the exemplary embodiments are usable not only in the particular described combination, but rather also in other combinations, without departing from the scope.

### BRIEF DESCRIPTION OF THE DRAWING

The FIGURE shows schematic section view of a transmission arrangement in accordance with aspects of the present subject matter.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

The FIGURE shows a transmission arrangement 10 for a motor vehicle, which includes an electric machine or motor 14 arranged in a first housing part 12. In addition, the transmission arrangement 10 includes a second housing part 16, in which a component 18 of an internal combustion engine is accommodated. In the present case, the component 18 is, for example, a clutch, an oil supply device, a system for ensuring uniformity of rotation, such as dual-mass flywheels, a torsional vibration mass damper and/or a torsional vibration damper.

In addition, the transmission arrangement 10 includes a transmission 20, by which the electric machine 14 and the internal combustion engine, in particular its component 18, are connectable to an output shaft of the transmission 20 for transmitting torque with differently settable transmission ratios and/or gear stages. Selectively engageable gear stages are also referred to as gears. The transmission 20 is also referred to as a main transmission. The transmission 20 includes, for example, two planetary gear sets, by which the electric machine 14 and the internal combustion engine are connected to the drive train with transmission ratios that are settable largely independently of one another, in order to transmit torque. Therefore, multiple electric gears and internal combustion engine-gears are available for a particularly efficient power coupling. For this purpose, the transmission 20 includes particular shift elements in order to couple different elements of the planetary gear sets in each case to one another in a rotationally fixed manner. For example, a planet carrier of one of the two planetary gear sets adjacent to the component 18 functions as the output shaft. A sun gear or a ring gear alternatively functions as the output shaft, however. In addition, the transmission 20 also includes particular clutches in order to interrupt the torque transmission of the electric machine 14 and/or of the internal combustion engine or the component 18.

In addition, the transmission arrangement includes an intermediate shaft 22, which is connected to the output shaft of the transmission 20 in order to transmit torque to a differential 24 of the motor vehicle. The differential 24 is connected to a drive axle 25 of the motor vehicle, and so particular torques generated by the internal combustion engine and/or the electric machine are utilized for driving the motor vehicle.

The two housing parts 12, 16 are connected to each other at a separation point 26, in the present case by particular bolted connections 28. The separation point 26 is understood to be a circumferential separation. The two housing parts 12, 16 therefore form two halves of a two-shelled housing. As is apparent, the two shells or two housing parts 12, 16 form a parting plane, which is essentially orthogonal with respect to particular axes of rotation of the transmission 20 and also of the intermediate shaft 22. In this way, the interior space 30 is particularly easily sealed, particularly in comparison to a housing having more housing parts and/or assembly openings and covers. The axes of rotation correspond to an axial extension of the transmission arrangement 10 and of the transmission 20. The radial extension is orthogonal relative to the axial extension or direction.

The two housing parts 12, 16 together form an interior space 30. The transmission 20 and the electric machine 14 are arranged in the interior space 30. The intermediate shaft 22, at least with its axis of rotation, is also arranged radially within the interior space 30, as the result of which the transmission arrangement 10 is particularly compact. The radial position of the axis of rotation of the intermediate shaft 22 is therefore also located radially within the outer diameter of a stator 32 of the electric machine 14.

In addition, the transmission arrangement also includes an intermediate wall 34 which delimits a first subspace 36, in which the electric machine 14 in the interior space 30 is arranged, from the remaining interior space 30. As a result, despite a shared oil supply, a separate adjustment of the amount of oil for the transmission 20 and for the electric machine 14 is possible. A portion of the transmission 20 is also arranged in the first subspace 36, however, and supplied oil together with the electric machine 14. A nearly complete separation is also possible, however.

In addition, the first housing part 12 forms a cup-like structure, which, in the FIGURE, delimits the interior space 30 or the first subspace 36 toward the right. The first subspace 36 is also be referred to as an area or subarea of the interior space 30. Toward the right is a side facing away from the internal combustion engine and facing a wheel of the motor vehicle in the case of a transverse installation. A transverse installation is an installation position of the transmission arrangement 10, in which the transmission arrangement 10 extends with its main axis essentially parallel to the transverse direction and/or an axle 25 of the motor vehicle. As a result, due to the intermediate wall 34 and due to the position of the intermediate shaft 22, the electric machine 14 (i.e., stator 32 of the electric machine 14) is installed from the side of the internal combustion engine and an additional assembly opening is not necessary on the side of the wheel. The intermediate wall 34 is preferably arranged between the internal combustion engine and a wheel of the motor vehicle.

Due to the arrangement of the intermediate wall 34 essentially in the parting plane of the housing, the intermediate wall 34 is quickly and easily installed, for example, by being bolted together with the first housing part 12. After the insertion of the electric machine 14, the intermediate wall 34 is also inserted into the assembly opening of the first housing part 12 and, thereby, fix the electric machine in the first housing part 12. As a result, the assembly is particularly simple.

Finally, the intermediate shaft 22 and the transmission 20 are inserted into the interior space 30. The intermediate shaft 22 is supported at the intermediate wall 34 on the side of the electric machine 14. The supporting point 38 is formed by two projections, at which an angular tapered roller bearing is arranged. As a result, the intermediate shaft 22 is supported axially as well as radially. Due to the mounting of the intermediate shaft 22 at the intermediate wall 34 on the side of the electric machine 14, the transmission arrangement 10 is particularly well nested and, thereby, axially compact. Simultaneously, additional housing parts for support are dispensed with.

An element of the transmission 20 is also supported at the intermediate wall 34 on the side of the electric machine 14. The supporting point 40 for the transmission 20 forms a recess in the intermediate wall 34, which alternatively, for example, is a passage opening for connecting the transmission 20 to a rotor of the electric machine 14. In the present case, a planet carrier of a planetary gear set facing the electric machine 14 is rotationally fixed to the intermediate wall 34. As a result, the transmission 20 is supported axially as well as radially. Alternatively, the transmission 20 is only radially supported at the supporting point 40 and the transmission 20 itself absorbs axial loads. Alternatively, or additionally, particular other elements, such as a sun gear or a ring gear of the transmission 20, could also be supported at the intermediate wall 34. In the present case, the planet carrier is supported, since the planet carrier, in the case of the transmission 20, is fixedly coupled to the housing and is not rotatable. Therefore, the support is particularly simple. In addition, the non-rotating planet carrier easily seals a passage opening in the intermediate wall 34 at least to the extent that the first subspace 36 is supplied with a different amount of oil than the rest of the interior space 30. Additionally, due to the support of the element of the transmission 20 at the intermediate wall 34 on the side of the electric machine 14, the transmission arrangement 10 is particularly well nested and, thereby, axially compact. Simultaneously, additional housing parts for supporting the transmission arrangement 10 are dispensed with.

On the side of the internal combustion engine, i.e., the side on the left in the FIGURE facing away from or opposite the electric machine 14 and the wheel side, the second housing part 16 has a wall 42, which, similarly to the intermediate wall 34, protrudes into the interior space 30. The wall 42 further subdivides the interior space 30, namely into a separate subspace 44 for the component 18. As a result, another amount of oil is also set with respect to this component 18. The wall 42 is also understood, however, to be the part of the housing part 16 that delimits the interior space 30. In this case, the component 18 is therefore not arranged in the interior space 30.

The wall 42 is utilized for supporting the component 18. In addition, the wall 42, similarly to the intermediate wall 34, also supports the intermediate shaft and the transmission at their particular side facing the internal combustion engine and the component 18. As shown, the intermediate shaft 22 is also supported on the side of the internal combustion engine with an angular tapered roller bearing at particular projections of the wall 42. The transmission 20 is alternatively, or additionally, supported at the wall 42 with a shaft that protrudes through the wall 42.

As a result thereof, the number of necessary housing parts is very low. In addition, the assembly is simplified in this way. Due to the separate intermediate wall 34, the electric machine 14 is installed on the side of the internal combustion engine in the first housing part 12 and fixed there with the separate intermediate wall 34. The intermediate wall 34 is preferably detachably attached. Finally, the transmission 20 and the intermediate shaft 22 are arranged at the intermediate wall 34 and then automatically fixed in the interior space 30 between the two housing parts 12, 16 by connecting the second housing part 16 with the first housing part 12. An additional fixing or further assembly, apart from particular supports, is therefore not necessary. The transmission 20 and the intermediate shaft 22 are therefore clamped, for all intents and purposes, between the two housing parts 12, 16.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

10 transmission arrangement

12 first housing part

14 electric machine

16 second housing part

18 component of an internal combustion engine

20 transmission

22 intermediate shaft

24 differential

25 drive axle

26 separation point

28 threaded connection

30 interior space

32 stator

34 intermediate wall

36 subspace

38 supporting point of the intermediate shaft

40 supporting point of the transmission

42 wall

44 subspace

1-15. (canceled)

16. A transmission arrangement (10) for a motor vehicle, comprising:
a first housing part (12);
a second housing part (16);
an electric machine (14), the electric machine (14) being at least partially within the first housing part (12);
an internal combustion engine having a component (18) at least partially within the second housing part (16);
a transmission (20), the electric machine (14) and the component (18) of the internal combustion engine being connectable to an output shaft of the transmission (20) to transmit torque to the output shaft;
an intermediate shaft (22) connected to the output shaft to transmit the torque to a drive axle (25) of the motor vehicle; and
an intermediate wall (34),
wherein the first and second housing parts (12, 16) are connectable to each other to together define a common interior space (30), the transmission (20) and at least part of the intermediate shaft (22) being within the common interior space (30),
wherein the intermediate wall (34) delimits a subspace (36) of the common interior space (30) from remaining space of the common interior space (30), the electric machine (14) being within the subspace (36), and
wherein the intermediate shaft (22) is supported on the intermediate wall (34) at a side of the electric machine (14).

17. The transmission arrangement (10) of claim 16, wherein the intermediate shaft (22) is supported on a wall (42) of the second housing part (16), the wall (42) of the second housing part (16) being proximate a side of the internal combustion engine.

18. The transmission arrangement (10) of claim 17, wherein the wall (42) of the second housing part (16) delimits a further subspace (44) of the common interior space (30) for accommodating the component (18) of the internal combustion engine.

19. The transmission arrangement (10) of claim 16, wherein the transmission arrangement (10) is arranged in the motor vehicle in a transverse direction with the electric machine (14) on a wheel-side.

20. The transmission arrangement (10) of claim 16, wherein an axis of rotation of the intermediate shaft (22) is supported at a radial location at least partially within a radially outer diameter of a stator of the electric machine (14).

21. The transmission arrangement (10) of claim 16, wherein the first housing part (12) has an assembly opening, through which the electric machine (14) is insertable into and removable from the first housing part, the opening being at least partially enclosable by the intermediate wall (34).

22. The transmission arrangement (10) of claim 16, wherein the intermediate wall (34) seals with one or both of the first housing part (12) and the second housing part (16).

23. The transmission arrangement (10) of claim 16, wherein the intermediate wall (34) is attachable to one or both of the first housing part (12) and the second housing part (16).

24. The transmission arrangement (10) of claim 16, wherein the intermediate wall (34) is in a parting plane (26) between the first housing part (12) and the second housing part (16).

25. The transmission arrangement (10) of claim 16, wherein the common interior space (30) of the transmission arrangement (10) is defined only by the first housing part (12) and the second housing part (16).

26. The transmission arrangement (10) of claim 16, wherein the transmission (20) includes at least one planetary gear set, wherein at least one element of the at least one planetary gear set is supported at the intermediate wall (34).

27. The transmission arrangement (10) of claim 26, wherein the element of the planetary gear set is rotationally fixed to the intermediate wall.

28. The transmission arrangement (10) of claim 26, wherein the at least one planetary gear set includes two planetary gear sets, the at least one element supported at the intermediate wall being at least one element of a first planetary gear set of the two planetary gear sets, where the first planetary gear set is on a side of the electric machine (14).

29. The transmission arrangement (10) of claim 16, wherein the component (18) of the internal combustion engine is a clutch, an oil supply device, a dual-mass flywheel, a torsional vibration mass damper, a torsional vibration damper, an all-wheel distributor, or a converter transmission.

30. A method for assembling a transmission arrangement (10), comprising:
inserting an electric machine (14) into a first housing part (12) through an assembly opening of the first housing part (12), the first housing part (12) only having one assembly opening, the assembly opening being the one assembly opening of the first housing part (12);
arranging an intermediate wall (34) at the first housing part (12) to at least partially close the assembly opening after inserting the electric machine (14);
supporting an intermediate shaft (22) at the intermediate wall (34) axially adjacent the electric machine (14) after arranging the intermediate wall (34) at the first housing part (12);
attaching a second housing part (16) at one or both of the first housing part (12) and the intermediate wall (34) such that the first and second housing parts (16) together define a common interior space (30), the intermediate shaft (22) being supported at a wall (42) of the second housing part (16), the wall (42) of the second housing part (16) being proximate a side of an internal combustion engine, a component (18) of the internal combustion engine being within the second housing part (16); and
arranging a transmission (20) in the common interior space (30) such that at least one element of a planetary gear set of the transmission (20) is supported at the intermediate wall (34) and such that the transmission (20) is supported at the wall (42) of the second housing part (16).
